(19) United States
(12) Patent Application Publication
(10) Pub. No.: US 2004/0168047 A1
(43) Pub. Date: Aug. 26, 2004

(54) Processor and compiler for creating program for the processor

(75) Inventors: Shin-ichiro Fukai, Izumiotsu-shi (JP); Toshiya Kai, Ibaraki-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 10/783,282

(22) Filed: Feb. 20, 2004

(30) Foreign Application Priority Data
Feb. 24, 2003 (JP) 2003-046484

(51) Int. Cl. G06F 9/44

(52) U.S. Cl. 712/229

(57) ABSTRACT

The present invention provides a processor that can prevent a supervisor program from being executed incorrectly by a user program so as to ensure security and can improve the real time performance for a valid branch from the user program to the supervisor program. The processor 400 includes a CPU 401, a flash memory 404 for storing a program, and a invalid branch detection circuit 409. When branch instruction that changes an operation mode to another operation mode is executed by the program stored in the flash memory 404, the invalid branch detection circuit 409 determines whether there is a branch enable instruction in a branch destination address. In the absence of the branch enable instruction, the invalid branch detection circuit 409 outputs an invalid branch detection signal, thus preventing the supervisor program from being executed incorrectly by the user program.

### BACKGROUND OF THE INVENTION

1. Field of the Invention

The present invention relates to processors, and more particularly to branch instructions for controlling operation of a processor.

2. Description of the Related Art

A processor generally executes various types of processing such as data processing and arithmetic processing in accordance with a program stored in an instruction memory.

The above conventional processor will be described with reference to the drawings.

FIG. 6 is a block diagram showing an IC card system that uses a processor developed by a conventional technique.

As shown in FIG. 6, the IC card system includes the following: a CPU 101; an instruction ROM 102; a RAM 103; a flash memory 104; an external I/F 105; an antenna coil 106; an address bus 107a; a data bus 107d; an interrupt control circuit 108; and a branch enable address judgment circuit 109.

The CPU 101 includes an instruction fetch unit 1011, an instruction decode unit 1012, an instruction execution unit 1013, a program counter 1014, and a memory access control circuit 1015.

The CPU 101 reads instructions from the instruction ROM 102 or the flash memory 104 and successively executes the instructions. Program data can be added externally to the flash memory 104 via the antenna coil 106 and the external I/F 105.

FIG. 7 is a conceptual diagram showing the division of a memory space into areas when a processor developed by a conventional technique is used.

In FIG. 7, reference numeral 200 is a whole logical address space. The whole logical address space 200 is allocated to the external I/F 105, the instruction ROM 102, the RAM 103, and the flash memory 104. In the whole logical address space 200, the instruction ROM space includes a supervisor area 211 and an API area 212, the RAM area includes a supervisor area 221, an API area 222, and a user area 223, the flash memory includes a user area 231, and the external I/F includes a user area 241.

FIG. 8 is a conceptual diagram of a program for a processor developed by a conventional technique. In FIG. 8, an instruction set 3021 in a user program 302 describes the processing of execution transfer from the user program 302 to an instruction set 3011 in a supervisor program 301. An instruction set 3022 in the user program 302 describes the processing of execution transfer from the user program 302 to an instruction set 3012 in the supervisor program 301. The instruction set 3011 in the supervisor program 301 describes the processing of execution transfer from the user program 302 to the instruction set 3012 or 3013, although FIG. 8 does not show a detailed representation of the processing.

In the IC card system developed by a conventional technique, the user program 302 prevents the supervisor program 301 and the API program from being executed incorrectly, and when a branch involving operation mode transfer occurs, the following method is employed to ensure security (see, e.g., JP 2002-182931 A).

First, the address storing the supervisor program 301 or the API program that needs to be executed on the user program 302 is set to an arithmetic resistor. Second, a branch instruction is executed toward a specific branch enable address that is designated by the branch enable address judgment circuit 109. Third, the correctness of the address in the arithmetic resister is determined by a conditional decision program stored in the branch enable address. When the address in the arithmetic resistor is correct, a branch instruction is executed again toward the address storing the supervisor program 301 or the API program that needs to be executed on the user program 302.

When a branch instruction from the user program 302 is executed toward the address in the supervisor program 301 or the API program that is not designated by the branch enable address judgment circuit 109, the branch enable address judgment circuit 109 outputs an interrupt request, so that security can be ensured.

In the IC card system that uses the processor as described above, however, the conditional decision program should be executed at the time of execution transfer from the user program 302 to the supervisor program 301, and thus the real time performance is reduced.

### SUMMARY OF THE INVENTION

Therefore, with the foregoing in mind, it is an object of the present invention to provide a processor that can improve the real time performance while ensuring security for execution transfer, e.g., from a user program to a supervisor program.

A processor of the present invention includes a CPU, an instruction memory for storing a program, and an invalid branch detection unit. When a branch instruction that changes an operation mode to another operation mode is executed by the program stored in the instruction memory, the invalid branch detection unit determines whether there is a branch enable instruction in a branch destination address. In the presence of the branch enable instruction, the invalid branch detection unit permits a change in operation mode, while in the absence of the branch enable instruction, the invalid branch detection unit outputs an invalid branch detection signal.

In a processor having the above configuration of the present invention, the operation mode change indicates that, e.g., an operation mode is changed to another operation mode that requires a higher privilege than the original operation mode.

In a processor having the above configuration of the present invention, when a branch instruction from the user program is executed, e.g., toward the address in the supervisor program or the API program while a branch enable instruction is not stored in the branch destination address, the invalid branch detection unit outputs an invalid branch detection signal. This can prevent the supervisor program or the like from being executed incorrectly by the user program and thus can ensure security. Moreover, when the supervisor program or the API program is executed correctly on the user program, a branch instruction can be executed directly toward the address storing the supervisor program or the API program that needs to be executed on the user program. Therefore, it is possible to reduce the processing time for operation mode transfer and to improve the real time performance.

### BRIEF DESCRIPTION OF THE DRAWINGS

FIG. 1 shows the circuit structure of a processor in Embodiments 1, 2 and 3.

FIG. 2 is a conceptual diagram of a program in Embodiment 1.

FIG. 3 is a conceptual diagram of a program in Embodiments 2, 3 and 4.

FIG. 4 shows the circuit structure of a processor in Embodiment 2.

FIG. 5 shows the configuration of a compiler in Embodiment 5.

FIG. 6 shows the circuit structure of a conventional processor.

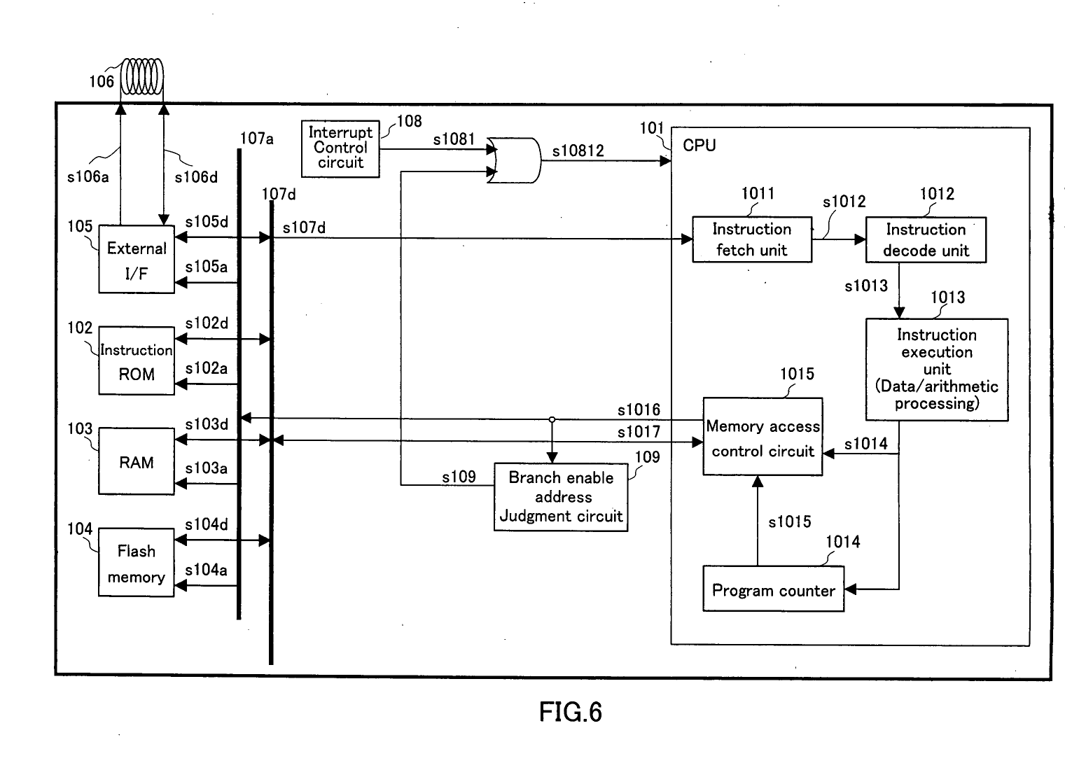

FIG. 7 shows the division of an address space into areas.

FIG. 8 is a conceptual diagram of a conventional program.

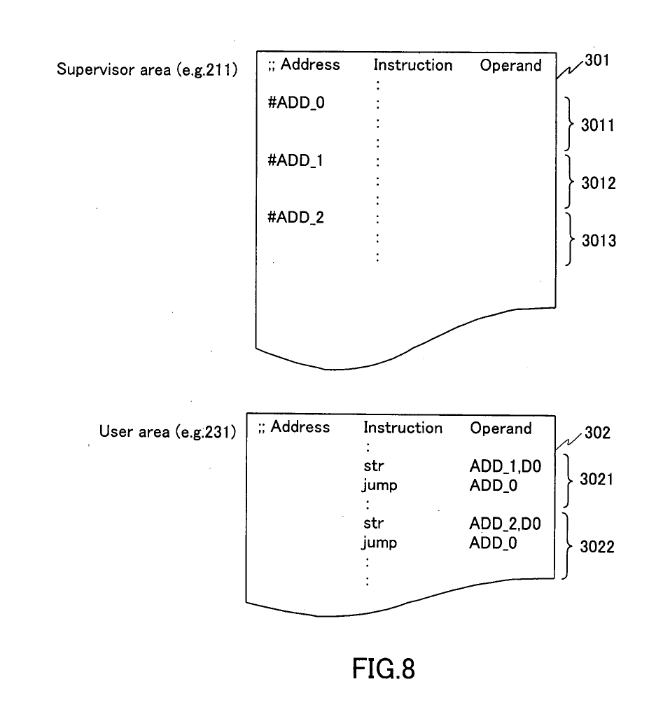

### DESCRIPTION OF THE PREFERRED EMBODIMENTS

The processor of the present invention may include the following: an execution area judgment unit that judges an execution area from a value of a program counter of an instruction executed by the CPU; an executive operation mode decision unit that decides an executive operation mode in accordance with the judgment of the execution area judgment unit; a branch destination area judgment unit that judges a branch destination area from a value of a branch destination address when a branch instruction is executed by the program stored in the instruction memory; a branch destination operation mode decision unit that decides a branch destination operation mode in accordance with the judgment of the branch destination area judgment unit; and an operation mode change detection unit that detects a change in operation mode by comparing the executive operation mode decided by the executive operation mode decision unit with the branch destination operation mode decided by the branch destination operation mode decision unit. It is preferable that when a branch instruction is executed by the program stored in the instruction memory while there is not a branch enable instruction in the branch destination address, the invalid branch detection unit outputs the invalid branch detection signal on condition that the operation mode change detection unit detects a change in operation mode.

In the above configuration, it is preferable that a specific instruction code that does not coincide with any other instructions is assigned to the branch enable instruction. This can improve the real time performance without affecting the resources for processing other instructions.

In the processor of the present invention, it is further preferable that when a branch instruction is executed by the program stored in the instruction memory while there is not a branch enable instruction in the branch destination address, the invalid branch detection unit outputs the invalid branch detection signal on condition that the operation mode change detection unit detects a change in operation mode, and the change in operation mode detected by the operation mode detection unit does not coincide with any change in operation mode specified by the branch enable instruction. In this configuration, it is preferable that an instruction code that corresponds to at least one of other instructions is assigned to the branch enable instruction. It is also preferable that the processor further includes a branch enable instruction code conversion unit that converts the instruction code of a branch enable instruction into an instruction code that corresponds to other instructions by detecting the branch enable instruction.

It is preferable that the processor of the present invention further includes an interrupt output unit that outputs an interrupt request to the CPU by detecting the invalid branch detection signal output from the invalid branch detection unit.

The processor of the present invention further may include a reset output unit that outputs a reset signal to the CPU by detecting the invalid branch detection signal output from the invalid branch detection unit.

The processor of the present invention further may include an instruction conversion unit that converts an instruction in a branch destination address into an undefined instruction by detecting the invalid branch detection signal output from the invalid branch detection unit.

A compiler of the present invention creates a program for the processor according to any of the above configurations. When a source program is compiled into an assembler, the compiler inserts the branch enable instruction in a predetermined position of a program in a supervisor area by determining a function structure and an operation mode in the source program.

Hereinafter, specific examples of a processor and a compiler of the present invention will be described with reference to the drawings.

Embodiment 1

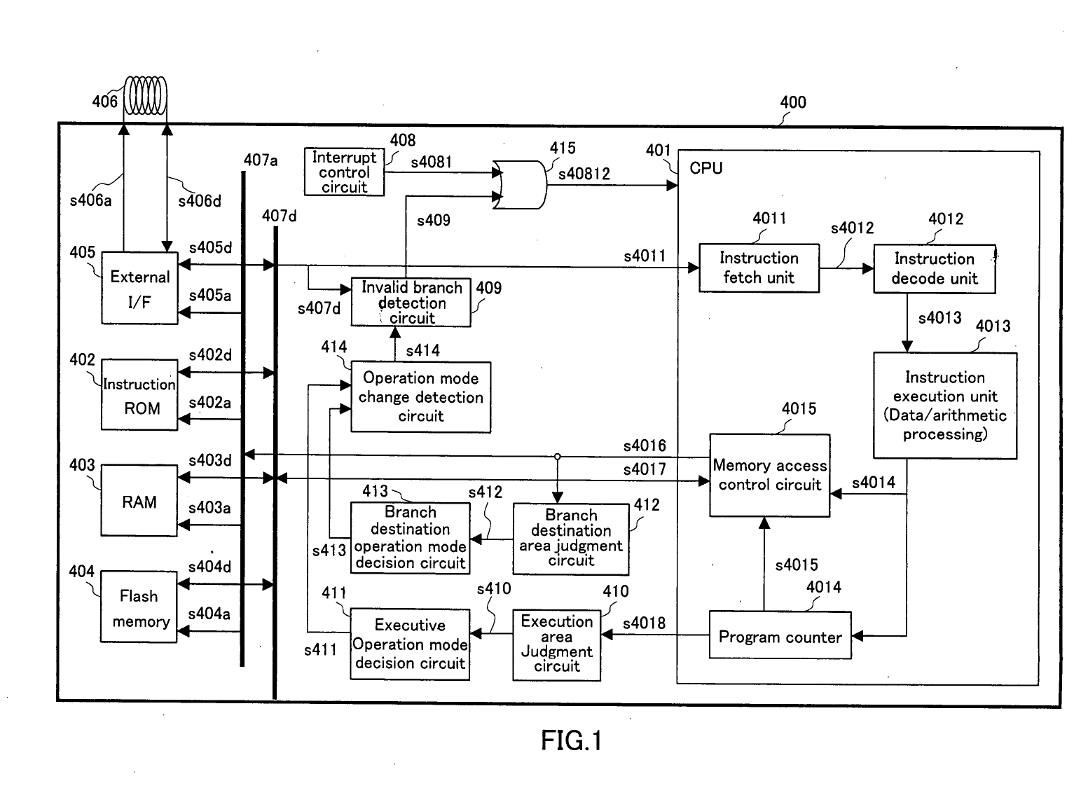

An embodiment of a processor 400 of the present invention will be described with reference to FIG. 1.

FIG. 1 is a block diagram showing an IC card system that uses a processor 400 of this embodiment.

As shown in FIG. 1, the IC card system includes the following: a CPU 401; an instruction ROM 402; a RAM 403; a flash memory 404; an external I/F 405; an antenna coil 406; an address bus 407a; a data bus 407d; an interrupt control circuit 408; an invalid branch detection circuit 409; an execution area judgment circuit 410; an executive operation mode decision circuit 411; a branch destination area judgment circuit 412; a branch destination operation mode decision circuit 413; and a operation mode change detection circuit 414.

The CPU 401 includes an instruction fetch unit 4011, an instruction decode unit 4012, an instruction execution unit 4013, a program counter 4014, and a memory access control circuit 4015.

The CPU 401 reads instructions from the instruction ROM 402 or the flash memory 404 and successively executes the instructions. Program data can be added externally to the flash memory 404 via the antenna coil 406 and the external I/F 405.

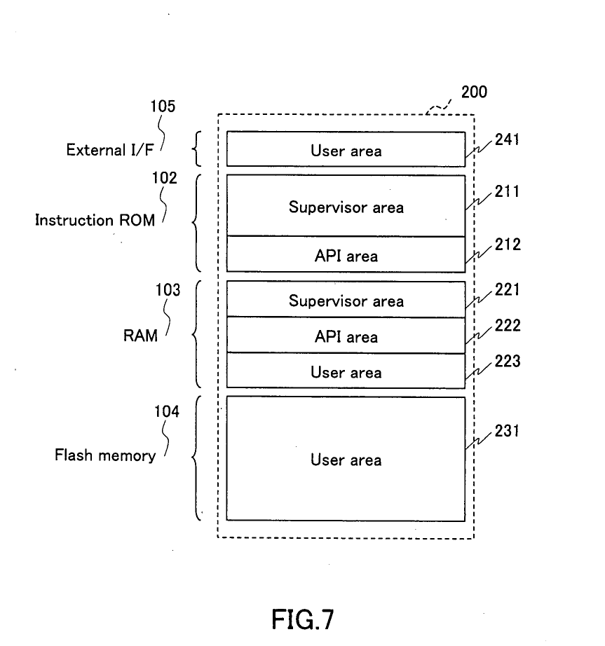

FIG. 7 is a conceptual diagram showing the division of a memory space into areas when a processor 400 of this embodiment is used.

In FIG. 7, reference numeral 200 is a whole logical address space. The instruction ROM space includes a supervisor area 211 and an API area 212, the RAM area includes a supervisor area 221, an API area 222, and a user area 223, the flash memory includes a user area 231, and the external I/F area includes a user area 241.

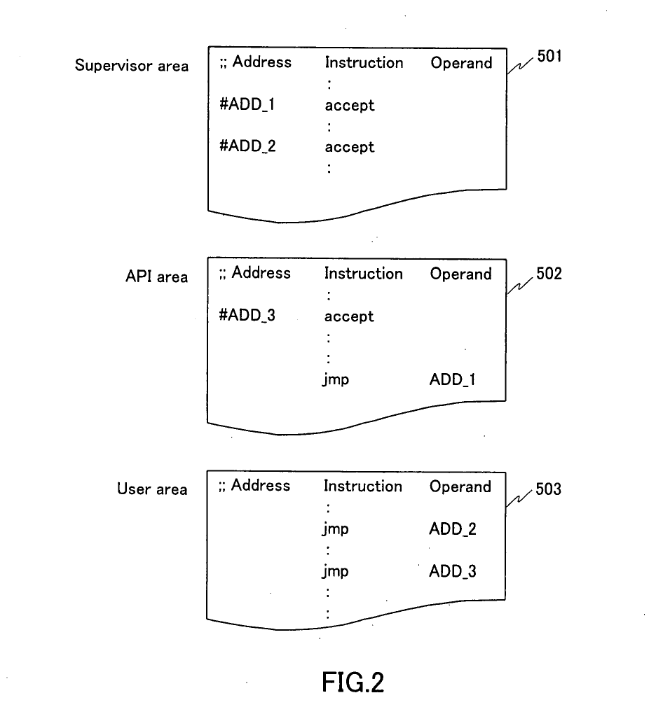

FIG. 2 is a conceptual diagram of a program for a processor 400 of this embodiment.

As shown in FIG. 2, a supervisor program 501 in the supervisor area and an API program 502 in the API area each include a branch enable instruction (accept) to specify whether a branch destination address is valid when the execution is transferred from a user program 503 in the user area to the supervisor program 501 in the supervisor area or the API program 502 in the API area by a branch instruction jmp). The branch enable instruction (accept) has a special instruction code that does not coincide with any instruction code of the existing instructions.

The execution area judgment circuit 410 judges from the value s4018 of an execution program counter in which area of the supervisor area, the API area, or the user area of the memory space as shown in FIG. 7 the instruction is currently being executed. The judgment is output to the executive operation mode decision circuit 411 as an execution area judgment signal s410. The executive operation mode decision circuit 411 sets the executive operation mode to any one of a supervisor mode, an API mode, and a user mode in accordance with the value of the execution area judgment signal s410 and outputs the result as an executive operation mode decision signal s411.

The CPU 401 selects the value s4015 of an instruction fetch program counter or the value s4014 of a branch destination address by using the memory access control circuit 4015 and outputs the result as a memory access address signal s4016.

The branch destination area judgment circuit 412 judges from the memory access address signal s4016 which area of the supervisor area, the API area, or the user area of the memory space as shown in FIG. 7 is the area of a branch destination. The judgment is output as a branch destination area judgment signal s412. The branch destination operation mode decision circuit 413 sets the operation mode to any one of the supervisor mode, the API mode, and the user mode in accordance with the value of the branch destination area judgment signal s412 and outputs the result as a branch destination operation mode decision signal s413.

The operation mode change detection circuit 414 detects a change in operation mode from the executive operation mode decision signal s411 and the branch destination operation mode decision signal s413 and outputs an operation mode change detection signal s414.

The invalid branch detection circuit 409 performs the following processing in accordance with the operation mode change detection signal s414 and instruction fetch data s407d.

When the invalid branch detection circuit 409 detects the generation of a branch instruction that involves execution transfer from the user program to the API program or the supervisor program by the operation mode change detection signal s414, the invalid branch detection circuit 409 decodes the instruction code stored in the branch destination address. When the decoded instruction code is not a branch enable instruction (accept) that enables a branch from the user program, the invalid branch detection circuit 409 activates an invalid branch detection signal s409.

Depending on the operation mode change detection signal s414, when the invalid branch detection circuit 409 detects no change in operation mode or when the invalid branch detection circuit 409 detects that even if the operation mode is changed, such a change in operation mode is neither a change from the user program to the API program nor a change from the user program to the supervisor program, the invalid branch detection circuit 409 inactivates an invalid branch detection signal s409.

The processing of the branch enable instruction (accept) in the CPU 401 can be performed in the shortest execution cycle without affecting the resources for data/arithmetic processing in the CPU 401 by enhancing the function of the instruction decode unit 4012 and allowing the control of the instruction execution unit 4013 to be the same as a no-operation instruction.

When a branch instruction that involves operation mode transfer is executed while a branch enable instruction that enables execution of the branch instruction is not stored in the branch destination address, the invalid branch detection circuit 409 outputs an invalid branch detection signal s409. The invalid branch detection signal s409 is sent to an OR circuit 415. The OR circuit 415 also receives an interrupt signal s4081 from the interrupt control circuit 408. When the invalid branch detection signal s409 is active, an interrupt request s40812 is output to the CPU 401.

This can prevent the supervisor program stored in the instruction ROM 402 from being executed incorrectly, e.g., by a user program that is added externally to the flash memory 404 and thus can ensure security. For correct processing, a branch instruction can be executed directly toward the address storing a program that needs to be executed, which makes it possible to perform operation mode transfer in the shortest execution cycle and to improve the real time performance.

In this embodiment, when the invalid branch detection signal s409 is active, an interrupt request is output to the CPU 401. However, a reset control circuit that outputs a reset signal to the CPU 401 may be used instead of the interrupt control circuit 408 as shown in FIG. 1. In such a case, when the invalid branch detection signal s409 is active, a reset signal s40812 is output to the CPU 401. The reset request as well as the interrupt request can provide the effect of preventing incorrect execution of the supervisor program.

Embodiment 2

The following is an explanation of an IC card system that uses a processor 400 of Embodiment 2 of the present invention.

The hardware configuration of the IC card system in this embodiment is the same as that of the IC card system in Embodiment 1 (see FIG. 1). Moreover, the division of a memory space into areas when a processor 400 of this embodiment is used also is the same as Embodiment 1 (see FIG. 7).

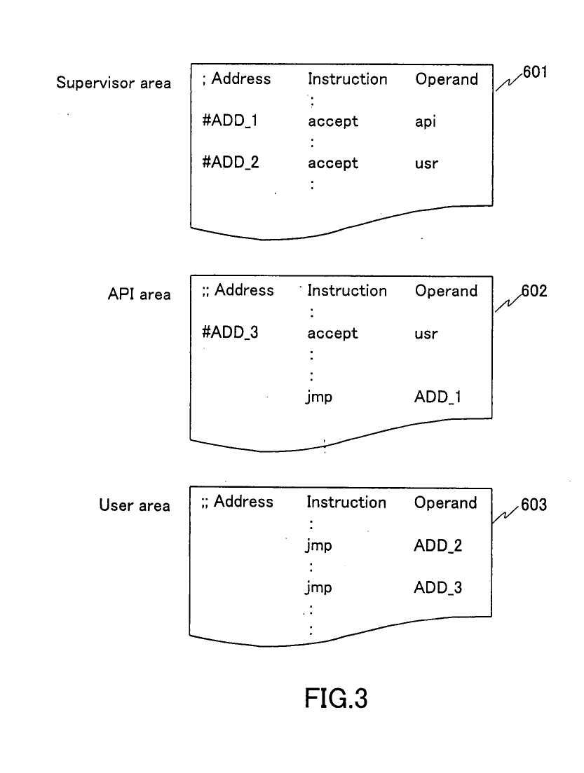

FIG. 3 is a conceptual diagram of a program for a processor 400 of this embodiment.

An API program 602 in an API area includes a branch enable instruction (accept usr) to specify whether a branch destination address in the API area is valid when the execution is transferred from a user program 603 in a user area to the API program 602 in the API area by a branch instruction jmp).

A supervisor program 601 in a supervisor area includes a branch enable instruction (accept usr) to specify whether a branch destination address in the supervisor area is valid when the execution is transferred from the user program 603 in the user area to the supervisor program 601 in the supervisor area by a branch instruction jmp).

The supervisor program 601 in the supervisor area further includes a branch enable instruction (accept api) to specify whether a branch destination address in the supervisor area is valid when the execution is transferred from the API program 602 in the API area to the supervisor program 601 in the supervisor area by a branch instruction (jmp).

The branch enable instruction (accept) has a special instruction code that does not coincide with any instruction code of the existing instructions.

The execution area judgment circuit 410 judges from the value s4018 of an execution program counter in which area of the supervisor area, the API area, or the user area of the memory space as shown in FIG. 7 the instruction is currently being executed. The judgment is output as an execution area judgment signal s410. The executive operation mode decision circuit 411 sets the executive operation mode to any one of a supervisor mode, an API mode, and a user mode in accordance with the value of the execution area judgment signal s410 and outputs the result as an executive operation mode decision signal s411.

The CPU 401 selects the value s4015 of an instruction fetch program counter or the value s4014 of a branch destination address by using the memory access control circuit 4015 and outputs the result as a memory access address signal s4016.

The branch destination area judgment circuit 412 judges from the memory access address signal s4016 which area of the supervisor area, the API area, or the user area of the memory space as shown in FIG. 7 is the area of a branch destination. The judgment is output as a branch destination area judgment signal s412. The branch destination operation mode decision circuit 413 sets the operation mode to any one of the supervisor mode, the API mode, and the user mode in accordance with the value of the branch destination area judgment signal s412 and outputs the result as a branch destination operation mode decision signal s413.

The operation mode change detection circuit 414 detects a change in operation mode from the executive operation mode decision signal s411 and the branch destination operation mode decision signal s413 and outputs an operation mode change detection signal s414.

The invalid branch detection circuit 409 performs the following processing in accordance with the operation mode change detection signal s414 and instruction fetch data s407d.

When the invalid branch detection circuit 409 detects the generation of a branch instruction that involves execution transfer from the user program to the API program or the supervisor program by the operation mode change detection signal s414, the invalid branch detection circuit 409 decodes the instruction code stored in the branch destination address. When the decoded instruction code is not a branch enable instruction (accept usr) that enables a branch from the user program, the invalid branch detection circuit 409 activates an invalid branch detection signal s409.

When the invalid branch detection circuit 409 detects the generation of a branch instruction that involves execution transfer from the API program to the supervisor program by the operation mode change detection signal s414, the invalid branch detection circuit 409 decodes the instruction code stored in the branch destination address. When the decoded instruction code is not a branch enable instruction (accept usr) that enables a branch from the user program or a branch enable instruction (accept api) that enables a branch from the API program, the invalid branch detection circuit 409 activates an invalid branch detection signal s409.

Depending on the operation mode change detection signal s414, when the invalid branch detection circuit 409 detects no change in operation mode or when the invalid branch detection circuit 409 detects that even if the operation mode is changed, such a change in operation mode is not any of the following: a change from the user program to the API program, a change from the user program to the supervisor program, or a change from the API program to the supervisor program, the invalid branch detection circuit 409 inactivates an invalid branch detection signal s409.

The processing of the branch enable instruction (accept) in the CPU 401 can be performed in the shortest execution cycle without affecting the resources for data/arithmetic processing in the CPU 401 by enhancing the function of the instruction decode unit 4012 and allowing the control of the instruction execution unit 4013 to be the same as a no-operation instruction.

When a branch instruction that involves operation mode transfer is executed while a branch enable instruction that enables execution of the branch instruction is not stored in the branch destination address, the invalid branch detection circuit 409 outputs an invalid branch detection signal s409.

The invalid branch detection signal s409 is sent to an OR circuit 415. The OR circuit 415 also receives an interrupt signal s4081 from the interrupt control circuit 408. When the invalid branch detection signal s409 is active, an interrupt request s40812 is output to the CPU 401. This can prevent the supervisor program stored in the instruction ROM 402 from being executed incorrectly, e.g., by a user program that is added externally to the flash memory 404 and thus can ensure security. For correct processing, a branch instruction can be executed directly toward the address storing a program that needs to be executed, which makes it possible to perform operation mode transfer in the shortest execution cycle and to improve the real time performance.

In this embodiment, when the invalid branch detection signal s409 is active, an interrupt request is output to the CPU 401. However, a reset control circuit that outputs a reset signal to the CPU 401 may be used instead of the interrupt control circuit 408 as shown in FIG. 1. In such a case, when the invalid branch detection signal s409 is active, a reset signal s40812 is output to the CPU 401. The reset request as well as the interrupt request can provide the effect of preventing incorrect execution of the supervisor program.

Embodiment 3

The following is an explanation of an IC card system that uses a processor 400 of Embodiment 3 of the present invention.

The hardware configuration of the IC card system in this embodiment is the same as that of the IC card system in Embodiment 1 (see FIG. 1). Moreover, the division of a memory space into areas when a processor 400 of this embodiment is used also is the same as Embodiment 1 (see FIG. 7).

FIG. 3 is a conceptual diagram of a program for a processor 400 of this embodiment.

An API program 602 in an API area includes a branch enable instruction (accept usr) to specify whether a branch destination address in the API area is valid when the execution is transferred from a user program 603 in a user area to the API program 602 in the API area by a branch instruction (jmp).

A supervisor program 601 in a supervisor area includes a branch enable instruction (accept usr) to specify whether a branch destination address in the supervisor area is valid when the execution is transferred from the user program 603 in the user area to the supervisor program 601 in the supervisor area by a branch instruction (jmp).

The supervisor program 601 in the supervisor area further includes a branch enable instruction (accept api) to specify whether a branch destination address in the supervisor area is valid when the execution is transferred from the API program 602 in the API area to the supervisor program 601 in the supervisor area by a branch instruction (jmp).

As described above, the program for the processor 400 of this embodiment is described in the same manner as Embodiment 2. However, the processor 400 of this embodiment differs from that of Embodiment 2 in the following point. For the processor 400 of this embodiment, a special instruction code is not assigned individually to the branch enable instruction (accept usr) that enables a branch from the user program and the branch enable instruction (accept api) that enables a branch from the API program. Instead, the same instruction code as any of the existing instructions, which is not frequently used on the actual program and does not affect the resources for data/arithmetic processing in the CPU 401, is assigned to the branch enable instructions.

The execution area judgment circuit 410 judges from the value s4018 of an execution program counter in which area of the supervisor area, the API area, or the user area of the memory space as shown in FIG. 7 the instruction is currently being executed. The judgment is output as an execution area judgment signal s410. The executive operation mode decision circuit 411 sets the executive operation mode to any one of a supervisor mode, an API mode, and a user mode in accordance with the value of the execution area judgment signal s410 and outputs the result as an executive operation mode decision signal s411.

The CPU 401 selects the value s4015 of an instruction fetch program counter or the value s4014 of a branch destination address by using the memory access control circuit 4015 and outputs the result as a memory access address signal s4016.

The branch destination area judgment circuit 412 judges from the memory access address signal s4016 which area of the supervisor area, the API area, or the user area of the memory space as shown in FIG. 7 is the area of a branch destination. The judgment is output as a branch destination area judgment signal s412. The branch destination operation mode decision circuit 413 sets the operation mode to any one of the supervisor mode, the API mode, and the user mode in accordance with the value of the branch destination area judgment signal s412 and outputs the result as a branch destination operation mode decision signal s413.

The operation mode change detection circuit 414 detects a change in operation mode from the executive operation mode decision signal s411 and the branch destination operation mode decision signal s413 and outputs an operation mode change detection signal s414.

The invalid branch detection circuit 409 performs the following processing in accordance with the operation mode change detection signal s414 and instruction fetch data s407d.

When the invalid branch detection circuit 409 detects the generation of a branch instruction that involves execution transfer from the user program to the API program or the supervisor program by the operation mode change detection signal s414, the invalid branch detection circuit 409 decodes the instruction code stored in the branch destination address. When the decoded instruction code is not a branch enable instruction (accept usr) that enables a branch from the user program, the invalid branch detection circuit 409 activates an invalid branch detection signal s409.

When the invalid branch detection circuit 409 detects the generation of a branch instruction that involves execution transfer from the API program to the supervisor program by the operation mode change detection signal s414, the invalid branch detection circuit 409 decodes the instruction code stored in the branch destination address. When the decoded instruction code is not a branch enable instruction (accept usr) that enables a branch from the user program or a branch enable instruction (accept api) that enables a branch from the API program, the invalid branch detection circuit 409 activates an invalid branch detection signal s409.

Depending on the operation mode change detection signal s414, when the invalid branch detection circuit 409 detects no change in operation mode or when the invalid branch detection circuit 409 detects that even if the operation mode is changed, such a change in operation mode is not any of the following: a change from the user program to the API program, a change from the user program to the supervisor program, or a change from the API program to the supervisor program, the invalid branch detection circuit 409 inactivates an invalid branch detection signal s409.

The branch enable instruction (accept) is assigned to the same instruction code as any of the existing instructions, and thus an existing decoder can be used as the instruction decode unit 4012. Moreover, the processing of the branch enable instruction (accept) in the CPU 401 can be performed in the same manner and execution cycle as the assigned existing instructions.

When a branch instruction that involves operation mode transfer is executed while a branch enable instruction that enables execution of the branch instruction is not stored in the branch destination address, the invalid branch detection circuit 409 outputs an invalid branch detection signal s409.

The invalid branch detection signal s409 is sent to an OR circuit 415. The OR circuit 415 also receives an interrupt signal s4081 from the interrupt control circuit 408. When the invalid branch detection signal s409 is active, an interrupt request s40812 is output to the CPU 401. This can prevent the supervisor program stored in the instruction ROM 402 from being executed incorrectly, e.g., by a user program that is added externally to the flash memory 404 and thus can ensure security.

For correct processing, a branch instruction can be executed directly toward the address storing a program that needs to be executed, which makes it possible to perform operation mode transfer in the same execution cycle as the execution cycle per existing instruction assigned to the branch enable instructions and to improve the real time performance. Moreover, the use of existing components can make it easier to design the CPU 401.

In this embodiment, when the invalid branch detection signal s409 is active, an interrupt request is output to the CPU 401. However, a reset control circuit that outputs a reset signal to the CPU 401 may be used instead of the interrupt control circuit 408 as shown in FIG. 1. In such a case, when the invalid branch detection signal s409 is active, a reset signal s40812 is output to the CPU 401. The reset request as well as the interrupt request can provide the effect of preventing incorrect execution of the supervisor program.

Embodiment 4

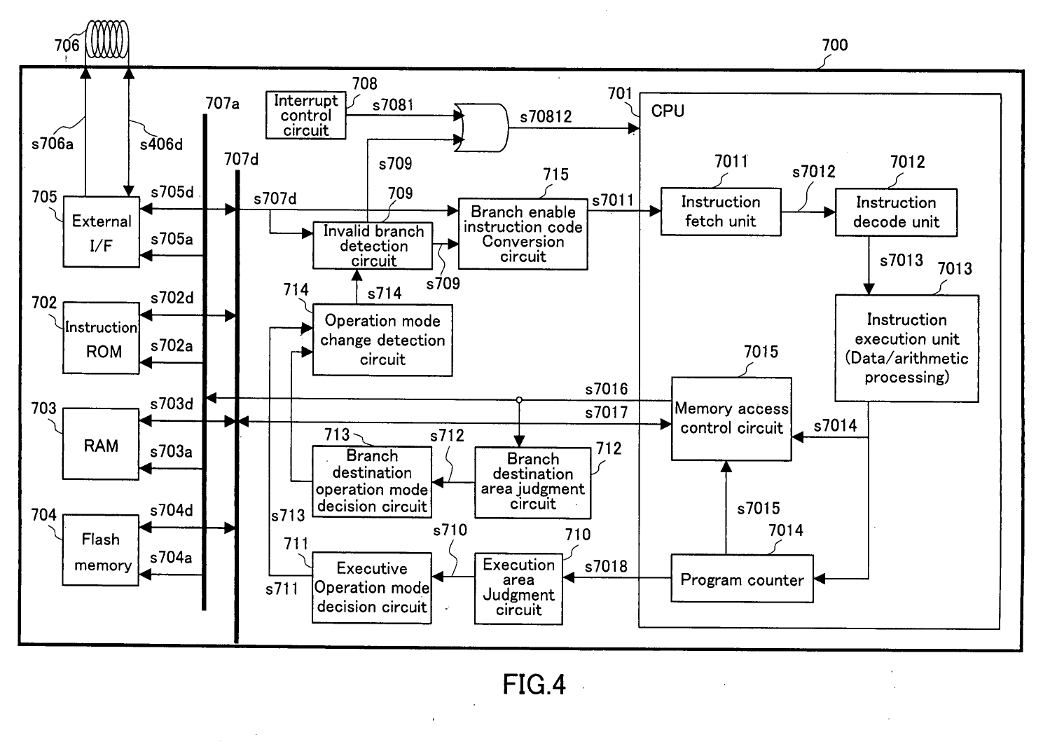

FIG. 4 is a block diagram showing an IC card system that uses a processor 700 of Embodiment 4.

As shown in FIG. 4, the IC card system includes the following: a CPU 701; an instruction ROM 702; a RAM 703; a flash memory 704; an external I/F 705; an antenna coil 706; an address bus 707a; a data bus 707d; an interrupt control circuit 708; an invalid branch detection circuit 709; an execution area judgment circuit 710; an executive operation mode decision circuit 711; a branch destination area judgment circuit 712; a branch destination operation mode decision circuit 713; an operation mode change detection circuit 714; and a branch enable instruction code conversion circuit 715.

The CPU 701 includes an instruction fetch unit 7011, an instruction decode unit 7012, an instruction execution unit 7013, a program counter 7014, and a memory access control circuit 7015.

The CPU 701 reads instructions from the instruction ROM 702 or the flash memory 704 and successively executes the instructions. Program data can be added externally to the flash memory 704 via the antenna coil 706 and the external I/F 705.

The division of a memory space into areas when a processor 700 of this embodiment is used is shown in FIG. 7, which has been referred to in Embodiment 1.

FIG. 3 is a conceptual diagram of a program for processor 700 of Embodiment 4.

An API program 602 in an API area includes a branch enable instruction (accept usr) to specify whether a branch destination address in the API area is valid when the execution is transferred from a user program 603 in a user area to the API program 602 in the API area by a branch instruction jmp).

A supervisor program 601 in a supervisor area includes a branch enable instruction (accept usr) to specify whether a branch destination address in the supervisor area is valid when the execution is transferred from the user program 603 in the user area to the supervisor program 601 in the supervisor area by a branch instruction (jmp).

The supervisor program 601 in the supervisor area further includes a branch enable instruction (accept api) to specify whether a branch destination address in the supervisor area is valid when the execution is transferred from the API program 602 in the API area to the supervisor program 601 in the supervisor area by a branch instruction (jmp).

As described above, the program for the processor 700 of this embodiment is described in the same manner as Embodiment 3. In this embodiment, however, the branch enable instruction (accept) has a special instruction code that does not coincide with any instruction code of the existing instructions.

The execution area judgment circuit 710 judges from the value s7018 of an execution program counter in which area of the supervisor area, the API area, or the user area of the memory space as shown in FIG. 7 the instruction is currently being executed. The judgment is output as an execution area judgment signal s710. The executive operation mode decision circuit 711 sets the executive operation mode to any one of a supervisor mode, an API mode, and a user mode in accordance with the value of the execution area judgment signal s710 and outputs the result as an executive operation mode decision signal s711.

The CPU 701 selects the value s7015 of an instruction fetch program counter or the value s7014 of a branch destination address by using the memory access control circuit 7015 and outputs the result as a memory access address signal s7016.

The branch destination area judgment circuit 712 judges from the memory access address signal s7016 which area of the supervisor area, the API area, or the user area of the memory space as shown in FIG. 7 is the area of a branch destination. The judgment is output as a branch destination area judgment signal s712. The branch destination operation mode decision circuit 713 sets the operation mode to any one of the supervisor mode, the API mode, and the user mode in accordance with the value of the branch destination area judgment signal s712 and outputs the result as a branch destination operation mode decision signal s713.

The operation mode change detection circuit 714 detects a change in operation mode from the executive operation mode decision signal s711 and the branch destination operation mode decision signal s713 and outputs an operation mode change detection signal s714.

The invalid branch detection circuit 709 performs the following processing in accordance with the operation mode change detection signal s714 and instruction fetch data s707d.

When the invalid branch detection circuit 709 detects the generation of a branch instruction that involves execution transfer from the user program to the API program or the supervisor program by the operation mode change detection signal s714, the invalid branch detection circuit 709 decodes the instruction code stored in the branch destination address. When the decoded instruction code is not a branch enable instruction (accept usr) that enables a branch from the user program, the invalid branch detection circuit 709 activates an invalid branch detection signal s709.

When the invalid branch detection circuit 709 detects the generation of a branch instruction that involves execution transfer from the API program to the supervisor program by the operation mode change detection signal s714, the invalid branch detection circuit 709 decodes the instruction code stored in the branch destination address. When the decoded instruction code is not a branch enable instruction (accept usr) that enables a branch from the user program or a branch enable instruction (accept api) that enables a branch from the API program, the invalid branch detection circuit 709 activates an invalid branch detection signal s709.

Depending on the operation mode change detection signal s714, when the invalid branch detection circuit 709 detects no change in operation mode or when the invalid branch detection circuit 709 detects that even if the operation mode is changed, such a change in operation mode is not any of the following: a change from the user program to the API program, a change from the user program to the supervisor program, or a change from the API program to the supervisor program, the invalid branch detection circuit 709 inactivates an invalid branch detection signal s709.

When the invalid branch detection signal s709 is inactive, the branch enable instruction code conversion circuit 715 converts the instruction code of the branch enable instruction (accept usr) that enables a branch from the user program or the instruction code of the branch enable instruction (accept api) that enables a branch from the API program, both of the instruction codes being received as the instruction fetch data s707d, into a no-operation instruction. When the invalid branch detection signal s709 is active, the branch enable instruction code conversion circuit 715 converts all instruction codes, which are received as the instruction fetch data s707d, into an undefined instruction. Then, the branch enable instruction code conversion circuit 715 outputs an instruction fetch data signal s7011 to the CPU 701.

The branch enable instruction is converted into any of the existing instructions of the CPU 701, and thus an existing decoder can be used as the instruction decode unit 7012. Moreover, the processing in the CPU 701 can be performed in the same manner and execution cycle as the assigned exiting instructions.

When a branch instruction that involves operation mode transfer is executed while a branch enable instruction that enables execution of the branch instruction is not stored in the branch destination address, the invalid branch detection circuit 709 outputs an invalid branch detection signal s709. This can prevent the supervisor program stored in the instruction ROM 702 from being executed incorrectly, e.g., by a user program that is added externally to the flash memory 704 and thus can ensure security.

Moreover, the branch enable instruction code conversion circuit 715 outputs to the CPU 701 an instruction fetch data signal s70 11 that has been converted into an undefined instruction. The undefined instruction causes the CPU 701 to perform exceptional processing, which interferes with the subsequent instruction execution, so that security can be ensured.

For correct processing, a branch instruction can be executed directly toward the address storing a program that needs to be executed, which makes it possible to perform operation mode transfer in the shortest execution cycle and to improve the real time performance. Moreover, the use of existing components can make it easier to design the CPU 701.

In each of Embodiments 1 to 4, the invalid branch detection unit, the execution area judgment unit, the executive operation mode decision unit, and the like are formed individually as an independent circuit. However, any method for mounting these blocks can be employed, e.g., two or more blocks such as the execution area judgment unit and the executive operation mode decision unit may be provided as a single circuit. This configuration also is within the technical scope of the present invention.

In each of Embodiment 1 to 4, a processor of the present invention is applied to the IC card system. However, the application of a processor of the present invention is not limited thereto.

Embodiment 5

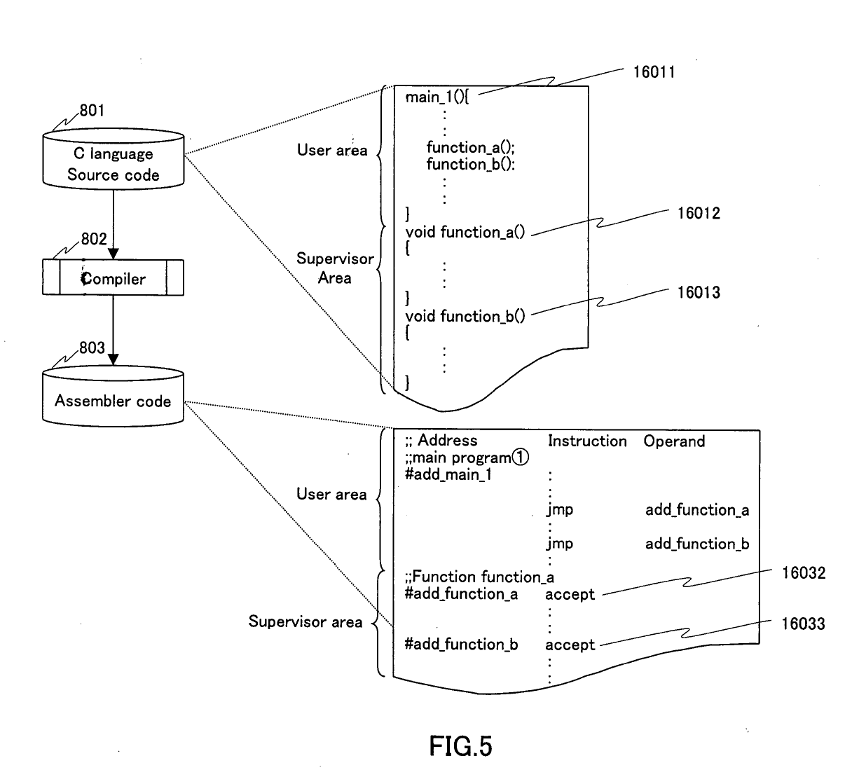

FIG. 5 shows the configuration and compile flow of a compiler of Embodiment 5.

A compiler 802 of this embodiment receives C language source codes 801 and compiles them into an assembler 803.

The C language source codes 801 include a main function (main_1) 16011 described in a user area and functions 16012 (unction_a), 16013 (function_b) described in a supervisor area. The main function (main_1) 16011 of the user program calls and uses the functions 16012 (function_a), 16013 (function_b) during programming.

For compiling, the compiler 802 judges in which area of the supervisor area or the user area the functions in the C language source codes 801 are described. Then, the compiler 802 determines the functions described in the supervisor area as a supervisor program. Moreover, the compiler 802 inserts branch enable instructions (accept) 16032, 16033 in front of the assembler codes generated from the source codes of the supervisor program.

Therefore, even if a system designer who develops a program in the supervisor area uses C language to describe the program, branch enable instructions (accept) can be inserted automatically during compiling. This can ensure security for the execution of instructions when a branch involving operation mode transfer occurs.

When a branch instruction from the user program is executed toward the address in the supervisor program or the API program while a branch enable instruction is not stored in the branch destination address, the invalid branch detection unit outputs an invalid branch detection signal. This can prevent the supervisor program from being executed incorrectly by the user program and thus can ensure security. Moreover, when the supervisor program or the API program is executed correctly on the user program, a branch instruction can be executed directly toward the address storing the supervisor program or the API program that needs to be executed on the user program. Therefore, it is possible to reduce the processing time for operation mode transfer and to improve the real time performance.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A processor comprising:
a CPU;
an instruction memory for storing a program; and
an invalid branch detection unit,
wherein when a branch instruction that changes an operation mode to another operation mode is executed by the program stored in the instruction memory, the invalid branch detection unit determines whether there is a branch enable instruction in a branch destination address, and in the presence of the branch enable instruction, the invalid branch detection unit permits a change in operation mode, while in the absence of the branch enable instruction, the invalid branch detection unit outputs an invalid branch detection signal.

2. The processor according to claim 1, further comprising:
an execution area judgment unit that judges an execution area from a value of a program counter of an instruction executed by the CPU;
an executive operation mode decision unit that decides an executive operation mode in accordance with the judgment of the execution area judgment unit;
a branch destination area judgment unit that judges a branch destination area from a value of a branch destination address when a branch instruction is executed by the program stored in the instruction memory;
a branch destination operation mode decision unit that decides a branch destination operation mode in accordance with the judgment of the branch destination area judgment unit; and
an operation mode change detection unit that detects a change in operation mode by comparing the executive operation mode decided by the executive operation mode decision unit with the branch destination operation mode decided by the branch destination operation mode decision unit,
wherein when a branch instruction is executed by the program stored in the instruction memory while there is not a branch enable instruction in the branch destination address, the invalid branch detection unit outputs the invalid branch detection signal on condition that the operation mode change detection unit detects a change in operation mode.

3. The processor according to claim 2, wherein when a branch instruction is executed by the program stored in the instruction memory while there is not a branch enable instruction in the branch destination address, the invalid branch detection unit outputs the invalid branch detection signal on condition that the operation mode change detection unit detects a change in operation mode, and the change in operation mode detected by the operation mode detection unit does not coincide with any change in operation mode specified by the branch enable instruction.

4. The processor according to claim 1, wherein a specific instruction code that does not coincide with any other instructions is assigned to the branch enable instruction.

5. The processor according to claim 1, wherein an instruction code that corresponds to at least one of other instructions is assigned to the branch enable instruction.

6. The processor according to claims 3, further comprising a branch enable instruction code conversion unit that converts the instruction code of a branch enable instruction into an instruction code that corresponds to other instructions by detecting the branch enable instruction.

7. The processor according to claim 1, further comprising an interrupt output unit that outputs an interrupt request to the CPU by detecting the invalid branch detection signal output from the invalid branch detection unit.

8. The processor according to claim 1, further comprising a reset output unit that outputs a reset signal to the CPU by detecting the invalid branch detection signal output from the invalid branch detection unit.

9. The processor according to claim 1, further comprising an instruction conversion unit that converts an instruction in a branch destination address into an undefined instruction by detecting the invalid branch detection signal output from the invalid branch detection unit.

10. A compiler for creating a program for the processor according to any one of claims 1 to 9,
wherein when a source program is compiled into an assembler, the compiler inserts the branch enable instruction in a predetermined position of a program in a supervisor area by determining a function structure and an operation mode in the source program.
